(19) United States
(12) Patent Application Publication
(10) Pub. No.: US 2022/0034373 A1
(43) Pub. Date: Feb. 3, 2022

(54) INTERIOR CLUTCH-USED CONTROL MECHANISM

(71) Applicant: JEN-CHIH LIU, Kaohsiung (TW)

(72) Inventor: JEN-CHIH LIU, Kaohsiung (TW)

(21) Appl. No.: 16/984,127

(22) Filed: Aug. 3, 2020

(51) Int. Cl. F16D 41/12; F16H 1/28; F16H 29/12

(52) U.S. Cl. CPC F16D 41/12; F16D 41/30; F16H 29/12; F16H 1/28

(57) ABSTRACT

A interior clutch-used control mechanism comprises a first control unit for controlling the fixedness of a sun gear; a second control unit for controlling engagements of inner gears at two sides and a planet frame; a third control unit for controlling the sun gear or the inner gears and the planet frame; and wherein power for control units are from rotary dynamic components, by displacements of driving rods for controlling operations of a cam or cam-like component; by using the cam or cam-like unit to function clutch or by using the cam or cam-like unit to drive a driven device to rotate or displace for operation of the clutch. By power rotating components of the internal clutch and cam or cam-like component, clutching components are controlled.

### FIELD OF THE INVENTION

The present invention relates to a bicycle internal clutch, and in particular to a interior clutch-used control mechanism.

### BACKGROUND OF THE INVENTION

The control mechanism of an internal clutch of a bicycle is complex and thus is heavy, large volume, and expensive. Meanwhile, it is insensitive in operation so as to deteriorate the quality of the clutch and the bicycle. Therefore, it is eager to develop and improve the prior art internal clutch of a bicycle.

Other than the designs of gears and paths of the internal clutch, to improve the driving rods and other structural elements of the internal clutches has related to the structures, weights and costs, and sensitivity and preciseness in controlling and the speed of change gears. Therefore, there is an eager demands to have an internal clutch with a the simple structures, light weights and low costs, and high sensitivity, high preciseness in controlling, fast speed in changing gears.

### SUMMARY OF THE INVENTION

The present invention relates to bikes, and in particular to a interior clutch-used control mechanism, in that, by power rotating components (such as input rings, inner gears planet frames, output rings, etc.) which rotates as the internal clutch and cam or cam-like component, clutching components are controlled. That is, using a cam or cam-like components to drive a driven device to rotate or displace so as to control the clutch to change gears. The internal clutch is commonly used to chainless bikes and chain contained bikes; has the advantages of saving storage space, light weight, low cost, high usages in industry. Furthermore the structure of the internal clutch is simple so that the efficiencies in assembly and repair are promoted. In the present invention by power rotating components (such as input rings, inner gears planet frames, output rings, etc.) which rotates as the internal clutch and cam or cam-like component, clutching components are controlled, such as to control the fixing of a sun gear, to control the engagements of the internal gear and planet gear. That is, using a cam or cam-like components to drive a driven device to rotate or displace so as to control the clutch to change gears

To achieve above object, the present invention provides a interior clutch-used control mechanism comprises a first control unit for controlling the fixedness of a sun gear; a second control unit for controlling engagements of inner gears at two sides and a planet frame; a third control unit for controlling the sun gear or the inner gears and the planet frame; and wherein power for control units are from rotary dynamic components, by displacements of driving rods for controlling operations of a cam or cam-like component; by using the cam or cam-like unit to function clutch or by using the cam or cam-like unit to drive a driven device to rotate or displace for operation of the clutch.

### BRIEF DESCRIPTION OF DRAWINGS

FIG. 1 is a partial assembly view of an internal clutch of a bike of the present invention.

FIG. 1A is a cross sectional view about an internal clutch for a bike of the present invention.

FIG. 2 is a cross sectional view that a sun gear is fixed to or freely displacement with respect to the axial clutching control unit.

FIG. 2A is an exploded view of the clutch shown in FIG. 2.

FIG. 3 is a cross sectional view about the axial separation control unit of FIG. 2.

FIG. 4 is a cross sectional view showing that a sun gear is fixed to or freely displacement with respect to the axial clutching control unit.

FIG. 5 is a schematic view showing the action of the claws of the radial separation control unit of FIG. 4.

FIG. 6 is a schematic view showing the claw operation for controlling the fixedness of the sun gear.

FIG. 7 is a cross sectional showing the control unit for the inner gears at two sides and the planet frame according to the present invention.

FIG. 7A is an exploded view of the structure shown in FIG. 7.

FIG. 8 is a schematic view showing the closing operation about the clutching claw.

FIG. 9 is a cross sectional view showing a embodiment, in that a control claw of a control unit is positioned on a fixing unit.

FIG. 9A is an exploded view of the structure shown in FIG. 9.

FIG. 10 is a schematic view about the operation of the clutching claw of FIG. 9.

FIG. 11 is a cross sectional view showing an embodiment of the present invention, in that a control unit is used to a axial clutching operation.

FIG. 11A is an exploded view of the structure shown in FIG. 11.

FIG. 12 is a cross sectional view showing an embodiment of the present invention, in that a control unit is used to a radial clutching operation.

### BRIEF DESCRIPTION OF THE INVENTION

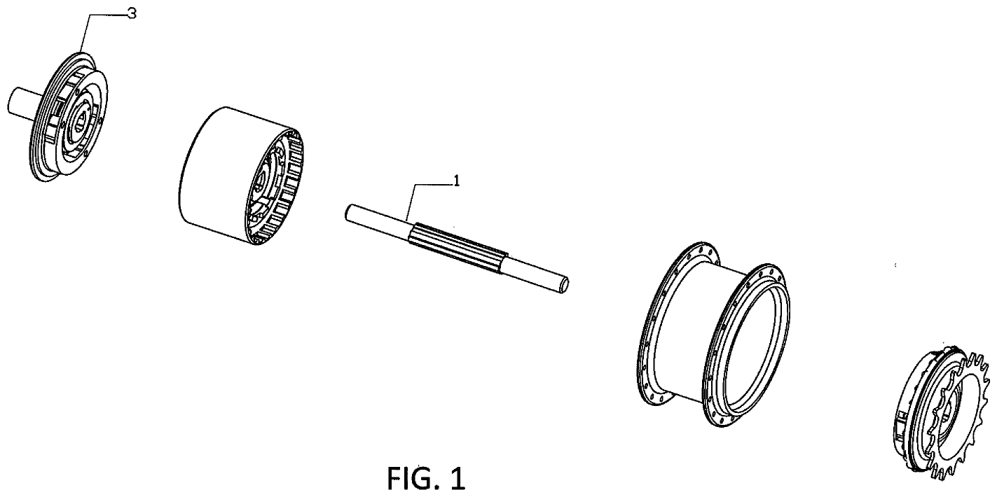

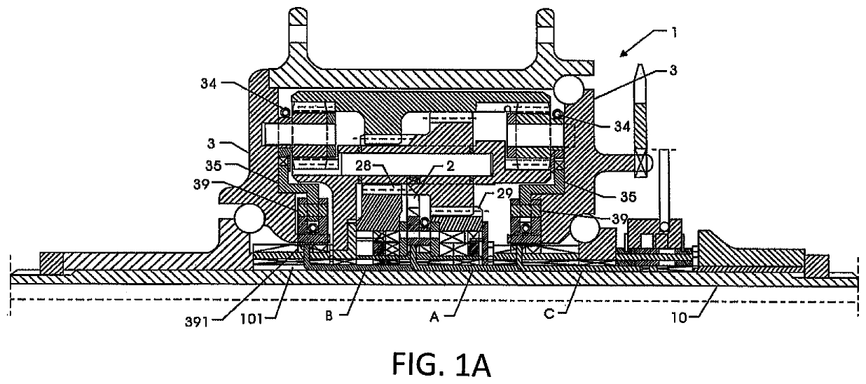

With reference to FIGS. 1 and 1A, a interior clutch-used control mechanism according to the present invention is illustrated. In the embodiment the control assembly includes a first control unit for controlling the fixedness of a sun gear; a second control unit for controlling the engagements of inner gears at two sides and a planet frame for locating a planet gear set; and a third control unit for widely controlling the sun gear or the inner gears and the planet frame. The main feature of the present invention is that the power of control units are mainly from rotary dynamic components of the clutch (such as input rings, inner gears, planet frames, output rings, etc.) by displacements of driving rods (including leftward and rightward displacements, upward and backward displacements, or angular displacements, etc. In the following, leftward and rightward displacements are used in the description of the present invention (but this is not used to confine the scope of the present invention) for controlling the operation of a cam or cam-like component with the use of a displacement of a driven device, for controlling a cam or a cam-like unit to drive the clutch components or with the use of a displacement of a driven device, for controlling the cam or cam-like unit to drive a driven device to rotate or displace for operation a clutching device.

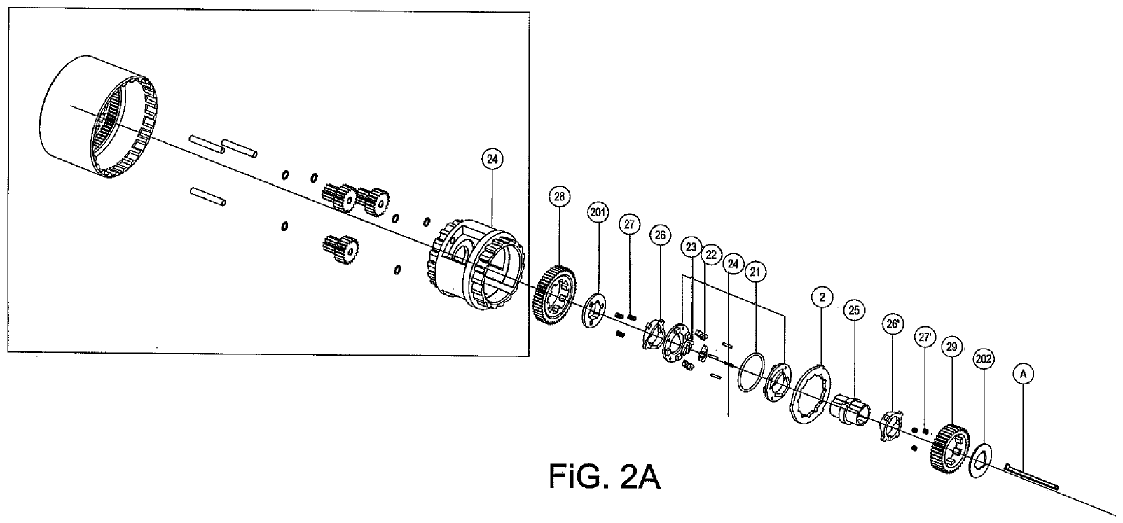

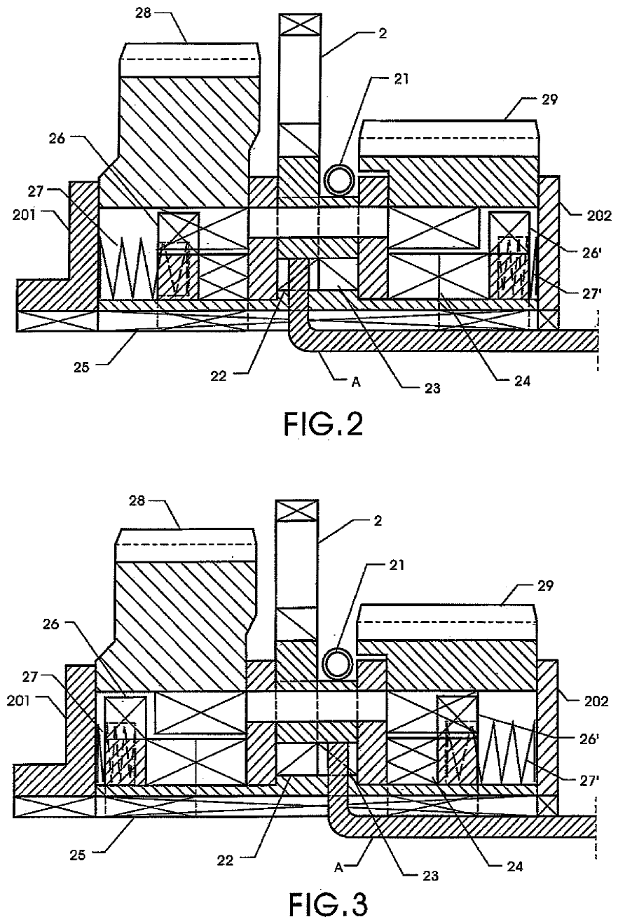

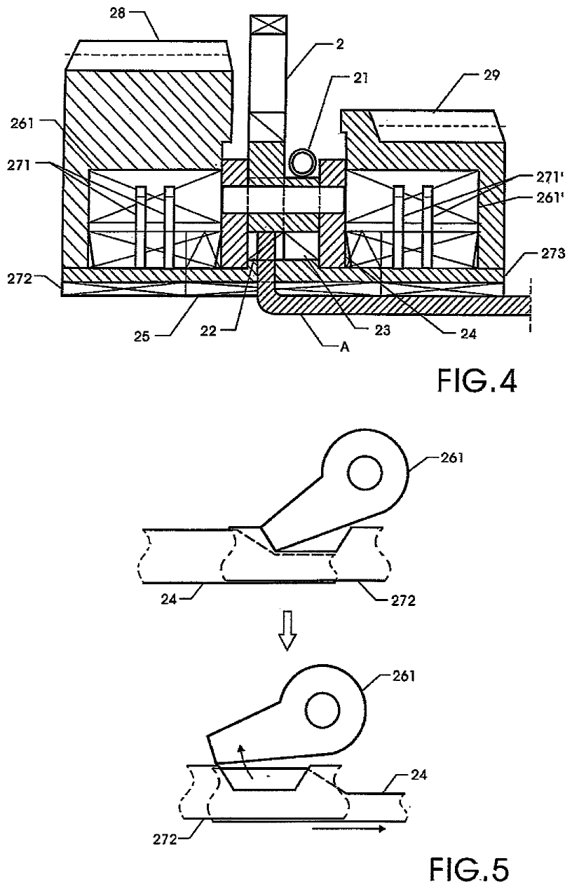

Referring to FIGS. 2, 2A, 3 and 4, it shows an embodiment, where it determines that a sun gear is fixed to an axial clutching control unit or a radial clutching control unit. In this the present invention, the structure is classified as an axial clutching form and a radial clutching form. FIG. 2 shows that a sun gear is fixed to or freely displacement with respect to the axial clutching control unit. FIG. 4 shows that a sun gear is fixed to or freely displacement with respect to the axial clutching control unit.

With reference to FIGS. 2, 2A and 3, the axial clutching control unit of the present invention is illustrated. The axial clutching control unit includes the following elements.

A center shaft 10 of the internal clutch 1 has at least one guide recess 101 for receiving a clutching driving rod.

An actuating sliding seat 25 is installed outside the center shaft 10. A surface of the sliding seat 25 is installed with a left gear 28, a ratchet ring 2 and a right gear 29. The ratchet gear ring 2 is installed between the left gear 28 and the right gear 29.

Between the left gear 28 and the center shaft 10 is installed with a left spring base 201, a left sliding block returning spring 27 and a left actuating sliding block 26 which is resisted by the sliding block returning spring 27 and is controlled by the cam base 24.

Between the right gear 29 and the center shaft 10 is installed with a right spring base 201, a right sliding block returning spring 27′ and a right actuating sliding block 26′ which is resisted by the sliding block returning spring 27 and is controlled by a cam base 24.

The cam base 24 is matched to the ratchet ring 2 and is installed with a first driving rod A. Movement of the cam base 24 will cause to drive one of a lift claw 22, a right claw 23 and a claw return spring 21, wherein the life claw 22 and the right claw 23 are installed on the cam base 23.

With reference to FIGS. 2 and 6, the operation of this embodiment will be described herein. Initially, the driving rod A of the axial clutching unit is at a left side. In FIGS. 1, 2, 3 and 4, the driving rod A moves leftwards and rightwards and in FIG. 6, the driving rod A moves forwards and backwards. Referring to FIGS. 2, 4 and 6, at an initial state, the driving rod A is at a left side and resists against the left claw 22, and another left claw 22 and two right claws 23 resists against the sliding seat 25 so that the left claws 22 do the right claws 23 are not in contact with the ratchet ring 2. At this time, the left gear 28 is fixed and the right gear 29 is freely rotatable. When it is needed to change speed, the left gear 28 is switched to be rotatable freely and the right gear 29 is switched to be fixed.

The process is that: Firstly the driving rod A moves rightwards so that the left claw 22 is ejected upwards to engage to the ratchet ring 2 so as to drive the cam base 24 to rotate. When the cam base 24 rotates, an axial cam pushes the left actuating sliding block 26 to leave from the left gear 28 so that the left gear 28 is free. Then the left sliding block returning spring 27 is compressed so that the left actuating sliding block 26 is ejected by the cam base 24 to move leftwards further.

The cam base 24 rotates continuously so that the by the driving of the right sliding block returning spring 27′, the right actuating sliding block 26′ returns to right side. As a result, the right gear 29 is engaged with the right actuating sliding block 26′.

By above mentioned action as illustrated in FIG. 3, the driving rod A moves leftwards to the initial position as illustrated in FIGS. 2 and 6.

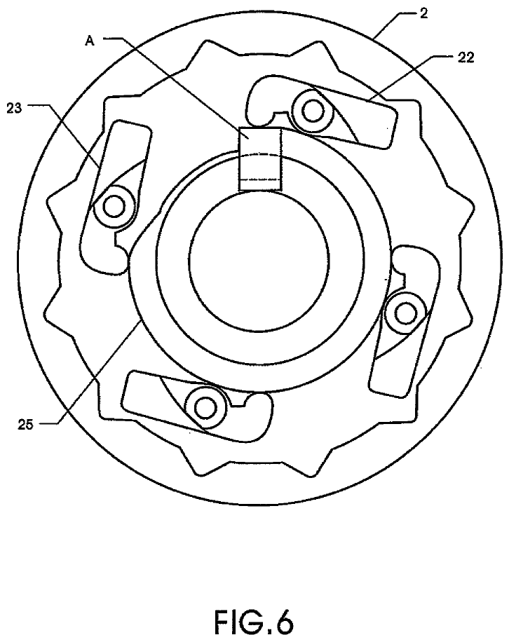

With reference to FIG. 4, a cross sectional view about the radial clutching unit of the present invention is illustrated. In this embodiment, the main structure is like those described above, while the cam of the cam base 24 is radially moved. The left actuating sliding block 26 is changed to a left stop claw 261 and the right actuating sliding block 26′ is changed to a right stop claw 261′. The left sliding returning spring 27 is changed to a left stop claw returning spring 271 and the right sliding returning spring 27′ is changed to a right stop claw returning spring 271′. A left claw base 272 and a right claw base 273 are fixed to a surface of a center shaft 10. The operation of the stop claw 261 is identical to those illustrated in FIG. 5 and the operation principle is also like the above mentioned.

With reference to FIGS. 1 and 6, the above mentioned control unit is performed by the fixedness of the sun gear. Since the fixedness of the ratchet ring 2 is by a rotation unit (such as an input ring, an inner gear, a planet frame, an output ring, etc. which rotates by changing gear). The function of the driving rod A serves to resist the claws 22, 23 not to engage with the ratchet ring 2. Therefore, it is not acted by input torque. Meanwhile, the left claw 22 and the right claw 23 are paired (as a two pair structure illustrated in FIG. 4) so that a 90 degree rotation causes an action. Therefore, the action is sequentially proceeded by a step for each time.

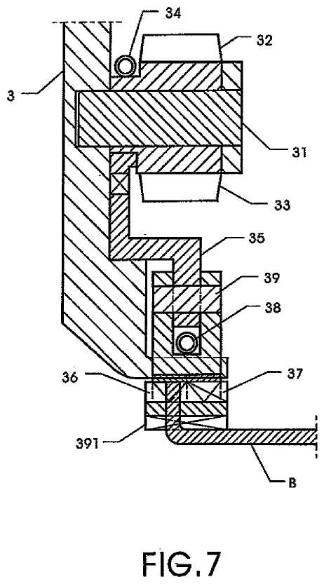

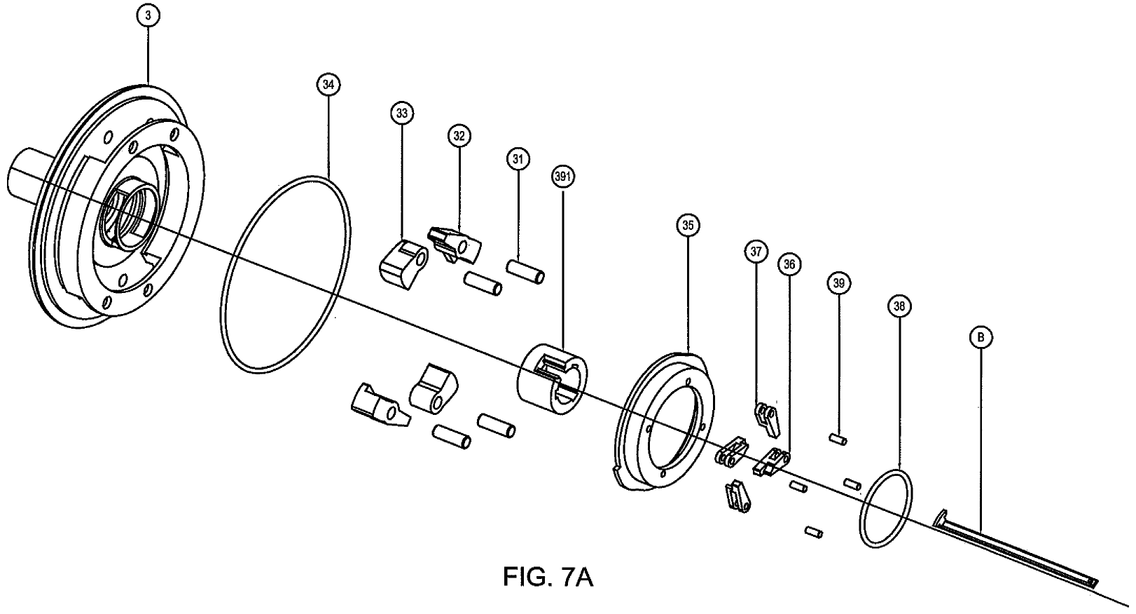

Referring to FIGS. 7 and 7A, the control unit for the inner gears at two sides and the planet frame according to the present invention is illustrated. By the position of the claws, the control is classified as two kinds. For one kind, the control claw is positioned at a linking device which is reacted with a power rotation unit. For another kind, the control claw is positioned a fixing unit. FIG. 7 shows an embodiment that the control claw is positioned on a linking device. The control unit includes the following elements.

For embodiment illustrated in FIGS. 1 and 7, a driving rod B, a control claw actuating seat 391 and a rotation ring 3 are installed at an outer side of a center shaft of an internal clutch. An inner side of the rotation ring 3 is installed with a claw shaft 31 for being assembled to an upper planet power clutching claw 32, a lower planet power clutching claw 33 and a clutching claw returning spring 34. A ratchet claw control panel 35 is installed below the ratchet claw. A controlling claw shaft 39 is used to control the left control claw 36 and a right control claw 37 and control the claw returning spring 38. The object of the control unit serves to control the closing of the upper planet power ratchet claw 32. With reference to FIGS. 7 and 7A, the left control claws 36 and the right control claws 37 are positioned and installed on the ratchet claw control panel 35 and are controlled by the ratchet claw control panel 35. As shown in FIG. 7, initially, the driving rod B or C is at the left side, and thus are filled into the notch of the control claw actuating seat 391. As a result, one of the left control claws 36 is supported and thus does not engaged with the control claw actuating seat 391, while another left control claw 36 and the two aright control claws 37 contact the surface of the control claw actuating seat 391.

As illustrated in the drawing, initially, the driving rod B or C is at left side, at this moment, the upper planet ratchet claw 32 opens and the right control claw 37 closes.

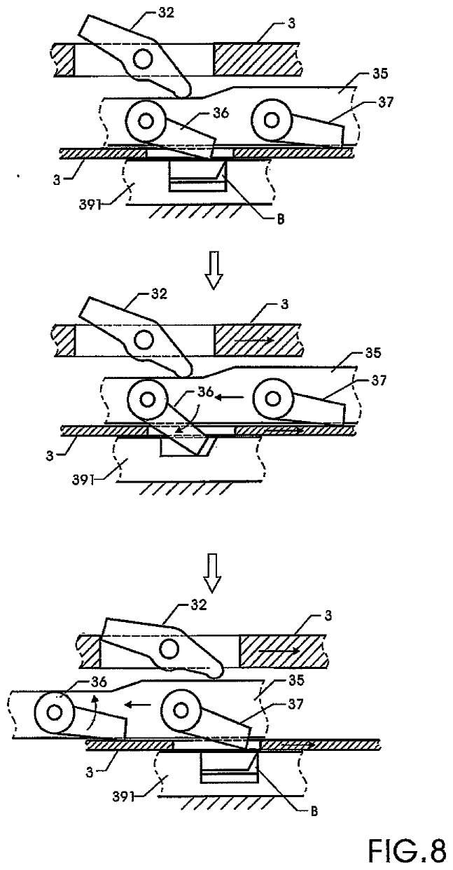

The action for closing the upper planet power ratchet claw 32 is that: the driving rod B moves transversally from a position locating the left control claw 36 to a position locating the right control claw 37 (referring to FIG. 8, the first and second steps). At this moment, the driving rod B or C does not support the left control claw 36 and is engaged with the notch of the control claw base 391 of the fixing unit. Therefore, the ratchet claw control panel 35 is fixed, even the ratchet claw control panel 35 rotates with respect to the rotation ring 3.

Rotation of the ratchet claw control panel 35 causes the upper planet power ratchet claw 32 closes. Then the left control claw 36 leaves by the action of the rotation ring 3 which rotates so as to leave from the notch of the control claw actuating seat 391, while the right control claw 37 moves to a notch to be supported by the driving rod B or C.

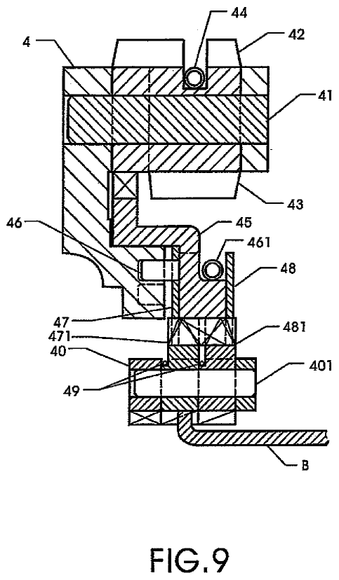

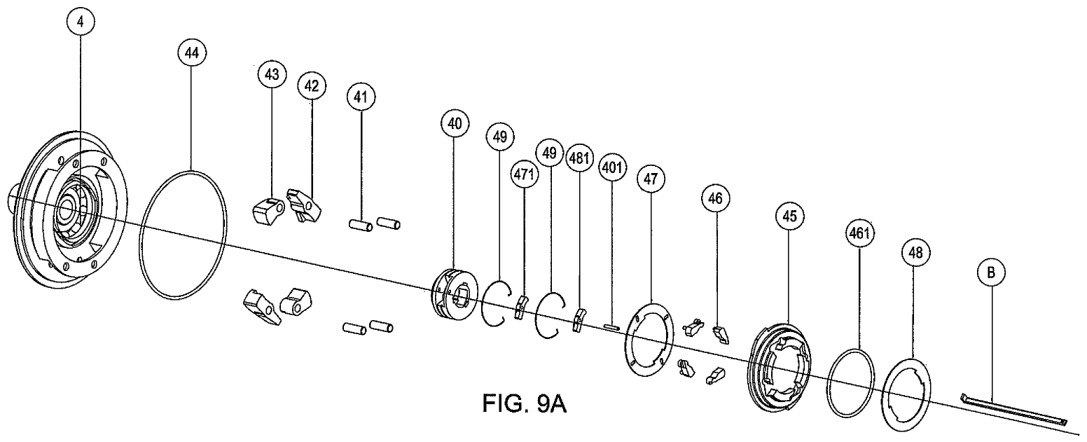

With reference to FIGS. 9 and 9A, an embodiment is illustrated. The embodiment of FIGS. 9 and 9A are similar to the embodiment shown in FIGS. 7 and 7A. The third control unit has a control claw which is positioned on a fixing unit.

In this embodiment, a driving rod B, a control claw fixing base 40 are installed on outside of a center shaft of the internal clutch. A control claw shaft 401, a control claw returning spring 49, a left control claw 471 and a right control claw 481 are installed on the control claw fixing base 40. An upper planet power ratchet claw 42, a lower planet power ratchet claw 43 and a ratchet claw returning spring 44 are installed on the rotation claw 4. A ratchet claw control panel 45 is installed below the ratchet claw. A left limiting panel 47, a right limiting panel 48 and an auxiliary claw returning spring 461 are installed at two sides below the ratchet claw control panel 45.

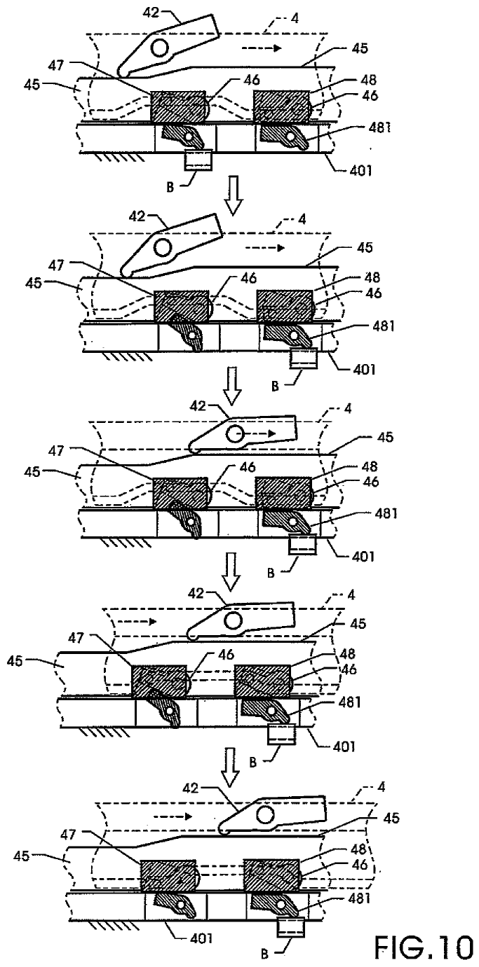

An auxiliary claw 46 is installed between the left control panel 47 and the rotation ring 4. As illustrated in the drawing, the control claw fixing base 40 and the rotation ring 4 are at initial positions. The driving rod B is at a left side and the left control claw is supported by the driving rod B. The ratchet claw control panel 45 is not engaged. At this time, the right control claw 481 is stopped by the auxiliary claw 46 and the right limiting panel 48 and cannot engage the ratchet claw control panel 45. Therefore, the ratchet claw control panel 45 is motionless and has no function of changing speed. When the driving rod B moves, it states to change speed. The operation is illustrated in FIG. 10.

Referring to FIG. 9, the driving rod B moves rightwards, and thus the left control claw 471 does not engage to the ratchet claw control panel 45 so that the ratchet claw control claw 45 cannot rotate.

As the rotation ring 4 rotates continuously so that the ratchet claw control panel 45 to control the cam of the upper planet power ratchet claw 42 to move leftwards. Therefore, the upper planet power ratchet claw 42 closes and to leave from the upper planet power ratchet claw 42.

After leaving from the upper planet power ratchet claw 42 and the rotation ring 4 rotates continuously. The auxiliary claw 46 is closed by the track of the rotation ring 4 so that the left control claw 47 returns to the leaving state. Then

the driving rod B is at the right stop position to resist the right control claw 481 so as to complete a change speed action.

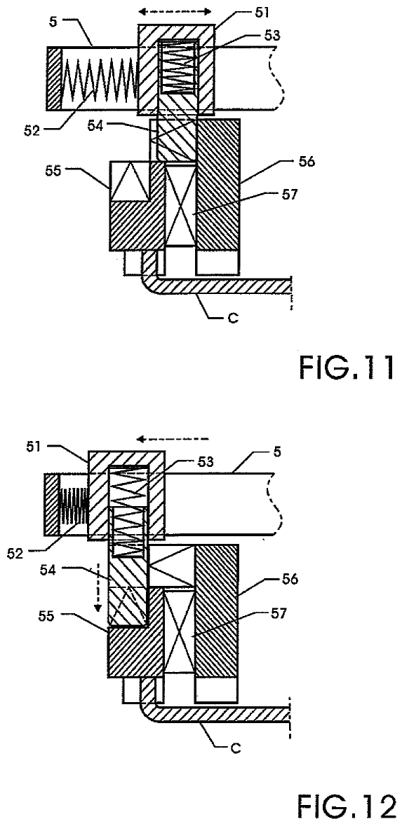

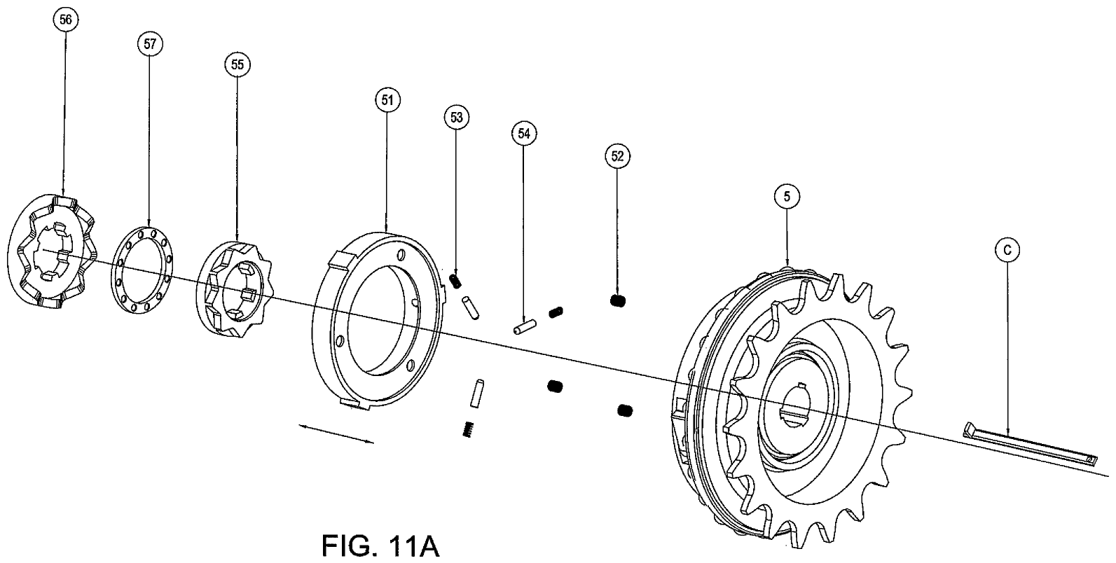

With reference to FIGS. 11 and 11A, an embodiment of the present invention is illustrated. The embodiment of FIGS. 11 and 11A are similar to the embodiment shown in FIGS. 7 and 7A. It shows a control unit which is widely used to a radial clutching and axial clutching operation.

In this embodiment, a driving rod C, a radial control cam ring 55, an axial control cam ring 56 are installed on an outer side of a center shaft of the internal clutch. A spacing ring 57 is installed between the radial control cam ring-55 and the axial control cam ring 56. A power rotation unit 5 is installed with a sliding ring 51 which is used as a linking device. An axial spring 52 is installed between an outer side of the sliding ring 51 and the rotation unit 5. An interior of the sliding ring 51 is installed with a pin 54 and a radial spring 53. By the displacement of the sliding ring 51, the pin 54 is moved to be retained to the radial control cam ring 55 or to the axial control cam ring 56 so as to achieve the object of clutching of the radial clutching effect or axial clutching effect.

When the driving rod C moves to and retained at the radial control cam ring 55, the pin 54 originally positioned to the radial control cam ring 55 is ejected upwards. By the axial spring 52, the sliding ring 51 moves rightwards. Then the sliding ring 51 and the axial control cam ring 56 rotates with the rotation unit 5, as those shown in FIGS. 11 and 11A.

In summary, in the control unit of an internal clutch, by power rotating components (such as input rings, inner gears planet frames, output rings, etc.) which rotates as the internal clutch and cam or cam-like component, clutching components are controlled, such as to control the fixing of a sun gear, to control the engagements of the internal gear and planet gear. That is, using a cam or cam-like components to drive a driven device to rotate or displace so as to control the clutch to change gears

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A interior clutch-used control mechanism comprising:
a driving rod;
an actuating sliding seat installed outside the driving rod; a surface of the sliding seat being installed with a left gear, a ratchet ring and a right gear; the ratchet gear ring being installed between the left gear and the right gear;
a left side of the left gear being installed with a left spring base, a left sliding block returning spring and a left actuating sliding block which is resisted by the sliding block returning spring and is controlled by the cam base;
a right side of the right gear being installed with a right spring base, a right sliding block returning spring and a right actuating sliding block which is resisted by the sliding block returning spring and is controlled by a cam base; and
the cam base being matched to the ratchet ring and being installed with the driving rod; movement of the cam base will cause to drive one of a lift claw, a right claw and a claw return spring.

2. The interior clutch-used control mechanism as claimed in claim 1, wherein the driving rod of an axial clutching unit is at a left side; at this time, the left gear is fixed and the right gear is freely rotatable; when it is needed to change speed, the left gear is switched to be rotatable freely and the right gear is switched to be fixed.

3. The interior clutch-used control mechanism as claimed in claim 2, wherein the driving rod moves rightwards so that the left claw is ejected upwards to engage to the ratchet ring so as to drive the cam base to rotate; when the cam base rotates, an axial cam pushes the left actuating sliding block to leave from the left gear so that the left gear is free; then the left sliding block returning spring is compressed so that the left actuating sliding block is ejected by the cam base to move leftwards further; and
the cam base rotates continuously so that the by the driving of the right sliding block returning spring, the right actuating sliding block returns to right side; as a result, the right gear is engaged with the right actuating sliding block.

4. (canceled)

5. (canceled)

6. (canceled)

7. A interior clutch-used control mechanism comprising:
a first control unit for controlling a fixedness of a sun gear;
wherein power for control the first units are from rotary dynamic components, by displacements of a plurality of driving rods for controlling operations of a cam or a cam-like component; by using the cam or cam-like unit to cause a clutch to be operated or by using the cam or the cam-like unit to drive a driven device to rotate or displace for operation of the clutch; and
wherein the first control unit is a clutching control unit and further comprising:
a driving rod;
an actuating sliding seat installed outside the driving rod; a surface of the sliding seat being installed with a left gear, a ratchet ring and a right gear; the ratchet ring being installed between the left gear and the right gear;
a left side of the left gear being installed with a left spring base, a left stop claw returning spring and a left stop claw which is resisted by the stop claw returning spring and being controlled by the cam base; and
a right side of the right gear being installed with a right spring base, a right stop claw returning spring and a right stop law which is resisted by the stop claw returning spring and being controlled by the cam base; and
a left claw base and a right claw base being installed outside the driving rod.

8. (canceled)

9. (canceled)

10. (canceled)

11. (canceled)

12. (canceled)

13. (canceled)

14. (canceled)

15. (canceled)
